(19) United States
(12) Patent Application Publication
(10) Pub. No.: US 2026/0103608 A1
(43) Pub. Date: Apr. 16, 2026

(54) METHOD FOR TREATING ASPHALT SHINGLES

(71) Applicant: PPG Industries Ohio, Inc., Cleveland, OH (US)

(72) Inventors: Kalsani Venkateshwarlu, Prospect, PA (US); John William Burgman, Wexford, PA (US); Kati Susanna Deegan, Helsinki (FI); Sara Vanessa Afonso Reis Teixeira, Amsterdam (NL); Erja Satumarja Malinen, Hyvinkää (FI)

(21) Appl. No.: 19/354,517

(22) Filed: Oct. 9, 2025

Related U.S. Application Data
(60) Provisional application No. 63/707,425, filed on Oct. 15, 2024.

(51) Int. Cl. C09D 5/14; A01N 43/78; A01N 43/84; A01P 13/00; C08J 7/04; C08K 5/00; C08K 5/205; C08K 5/378; C08K 5/44; C08K 5/47; C09D 7/63; C09D 125/14

(52) U.S. Cl. CPC C09D 5/14; A01N 43/78; A01N 43/84; A01P 13/00; C08J 7/0427; C09D 7/63; C09D 125/14; C08J 2395/00; C08J 2425/14; C08K 5/0091; C08K 5/205; C08K 5/378; C08K 5/44; C08K 5/47

(57) ABSTRACT

A method for treating an asphalt shingle comprises applying a coating composition to a surface of an asphalt shingle, or to granules formulated for use in a granule layer of an asphalt shingle. The coating composition includes: (a) a film-forming component; and (b) a biocide component. The biocide component comprises (i) a first organosulfur component, (ii) a second organosulfur component different from the first organosulfur component, and (iii) an organozinc compound. The coating composition optionally further comprises (iv) a nitrogen-containing heterocycle that includes an attached alkylamino group and/or an attached alkylthio group, and/or (v) a carbamate compound.

### CROSS-REFERENCE TO RELATED APPLICATIONS

This application claims priority to and the benefit of U.S. Provisional Patent Application No. 63/707,425, filed Oct. 15, 2024, the entirety of which is incorporated herein by reference.

### BACKGROUND

Asphalt shingles are commonly added to roof exteriors to waterproof the roof and protect the roof from the elements. A standard asphalt shingle includes a base layer, an asphalt mixture layer applied over the base layer, and an outer layer of mineral granules (i.e., granule layer) applied to the asphalt layer.

The base layer, typically formed from fiberglass, provides structural integrity and supports the other components of the asphalt shingle. The asphalt mixture layer typically includes asphalt and limestone. The asphalt mixture layer functions to waterproof the shingle and to provide adhesion for the granules of the outer layer. The granules used for the outer layer are often derived from crushed rock particles, and function to protect against UV light, protect against impacts from debris, and increase fire resistance.

Extended exposure to the elements eventually results in physical and chemical degradation of asphalt shingles. Algal growth on outer surfaces and within crevices of the asphalt shingle, in particular, contributes to degradation of the asphalt shingle. Algae can adhere to the granules of the outer layer, which can accelerate loosening, wearing, and loss of the protective granules. As granules are lost, the underlying layers become more exposed to the elements and thus more susceptible to degradation. Algae also tend to retain moisture at the shingle surface, further promoting degradation. Certain types of algae can absorb mineral components of the asphalt shingles such as the limestone in the asphalt mixture layer. The limestone essentially acts as a nutrient source promoting growth and spread of the algae, which accelerates deterioration of the shingle.

Conventional biocide approaches for asphalt shingles involve the use of copper-based or tin-based biocides. These compounds, however, are associated with risks to the environment, including aquatic toxicity and soil contamination, and to human health.

### SUMMARY

The present disclosure is directed to a method for treating an asphalt shingle comprises applying a coating composition to a surface of an asphalt shingle, or to granules formulated for use in a granule layer of an asphalt shingle. The coating composition includes: (a) a film-forming component; and (b) a biocide component. The biocide component comprises (i) a first organosulfur component, (ii) a second organosulfur component different from the first organosulfur component, and (iii) an organozinc compound. The coating composition optionally further comprises (iv) a nitrogen-containing heterocycle that includes an attached alkylamino group and/or an attached alkylthio group, and/or (v) a carbamate compound.

The present disclosure is also directed to an asphalt shingle treated according to the disclosed method. The present disclosure is also directed to treated granules for a granule layer of an asphalt shingle. The treated granules being treated according to the disclosed method.

### DETAILED DESCRIPTION

### Application Methods

The disclosed method comprises applying a coating composition to a surface of an asphalt shingle, or to granules formulated for use in a granule layer of an asphalt shingle. For example, the method can include applying the coating composition to the surface of an asphalt shingle while the asphalt shingle is in place upon a roof, or applying the coating composition to the surface of an asphalt shingle before placement of the asphalt shingle on a roof (e.g., during manufacture of the shingle).

Additionally, or alternatively, the method can include applying the coating composition to granules prior to placement of the granules on an asphalt mixture layer of an asphalt shingle. The granules can have, for example, an average particle size (number mean diameter) of 0.5 mm to 2.0 mm. The particle size can be determined using a standard test method known in the art, such as ASTM D451/D451M.

Application methods can include any that suitably apply the coating composition to an asphalt shingle surface, whether in position on a roof or prior to placement on a roof, or to granules prior to their application to an asphalt shingle. Application methods can include, for example, spray coating, dip coating, brush coating, roller coating, and/or coating using a fluidized bed and/or rotating pan (e.g., for granules).

### Asphalt Shingles

Asphalt shingles typically comprise a base layer, an asphalt mixture layer applied over the base layer, and an outer layer of mineral granules (i.e., granule layer) applied to the asphalt layer. The base layer can be formed from fiberglass and/or a cellulosic material, for example. The asphalt mixture layer can include asphalt and optionally stabilizers/fillers such as limestone and/or silica. The asphalt mixture layer can additionally include polymer additives as known in the art to influence material properties of the shingle such as flexibility. The outer layer can include granules formed from crushed rock (e.g., granite, basalt, slate, or combination thereof), for example. The asphalt shingles can optionally include other layers, such as a second asphalt layer applied beneath the base layer and/or a sealant layer (e.g., sealant strips) disposed to help the shingle adhere to an underlying surface and/or to adjacent shingles.

Note that while the examples disclosed herein relate to conventional asphalt shingles that comprise a base layer, an asphalt layer, and an outer layer of mineral granules, the method may also be applied to other, non-conventional shingle types that are otherwise susceptible to accelerated degradation due to algal growth. For example, shingles that include additional layers and/or substitute one layer for another can also benefit from treatment according to the disclosed methods. The definition of an asphalt shingle, as used herein, can optionally omit other roofing systems that are not typically understood to involve shingles, such as roofing systems based on tiles of clay or concrete or based on metal sheeting.

The term “asphalt” refers to a bituminous pitch that can be mixed with sand or gravel. Although “bitumen” technically refers to the binder and “asphalt” technically refers to the composite material made up of bitumen and aggregate, the terms are often used interchangeably in the field of roofing materials. As used herein, an “asphalt shingle” will be understood to be inclusive of roofing materials that use bitumen and/or are referred to as a bitumen product, such as bitumen shingles, modified bitumen rolls, and roll roofing products.

### Film-Forming Component

The film-forming component can include an aqueous dispersion of polymer particles or an emulsion of polymer particles. The polymer particles can be formed (e.g., via emulsion polymerization) from a set of ethylenically unsaturated monomers. For example, the set of ethylenically unsaturated monomers can include a (meth)acrylate monomer, and optionally, an aromatic monomer including an ethylenically unsaturated group, such as styrene.

The polymer particles can be included at 10 wt. % to 40 wt. %, such as 15 wt. % to 35 wt. %, such as 20 wt. % to 30 wt. %, or can be included within a range that uses any combination of the foregoing values as endpoints, based on total weight of the coating composition.

As used herein, an “ethylenically unsaturated” compound refers to a group having at least one carbon-carbon double bond and that can participate in polymerization reactions. The set of ethylenically unsaturated monomers can include a single type of ethylenically unsaturated monomer or can include a combination of multiple types of ethylenically unsaturated monomers. Thus, the set of ethylenically unsaturated monomers may include any combination of the types of ethylenically unsaturated monomers disclosed herein.

The ethylenically unsaturated monomer can include a (meth)acrylate, such as an alkyl (meth)acrylate and/or a cycloalkyl (meth)acrylate. Additionally, or alternatively, the ethylenically unsaturated monomer can include a di(meth)acrylate, such as a di(meth)acrylate formed from a diol, such as 1,4 butanediol di(meth)acrylate. Additionally, or alternatively, the ethylenically unsaturated monomer can comprise an ethylenically unsaturated monomer with an acid group, such as an ethylenically unsaturated monomer with a carboxylic acid group, such as a (meth)acrylic acid.

According to convention known to the skilled person, the terms “(meth)acrylic” and “(meth)acrylate” refer to both the acrylic/acrylate and methacrylic/methacrylate forms of the indicated compound. For example, (meth)acrylate monomers can include acrylate monomers (without the methyl substitution) and/or methacrylate monomers (with the methyl substitution). In addition, a “(meth)acrylic” or “(meth)acrylate” compound is inclusive of acrylic acid forms, acrylic acid anhydride forms, and derivatives thereof. Such derivatives include, for example, alkyl esters of acrylic acids, lower alkyl-substituted acrylic acids (e.g., C1-C2 substituted acrylic acids, such as methacrylic acid and/or ethyl substituted acrylic acid), and alkyl esters of lower alkyl-substituted acrylic acids (e.g., methyl methacrylate).

As used herein, an “alkyl (meth)acrylate” refers to an alkyl ester of a (meth)acrylic acid. An “alkyl” is a linear or branched (e.g., due to substitution) carbon chain functional group of the general formula CₙH₂ₙ₊₁ when positioned as a terminal group or CₙH₂ₙ when positioned as a non-terminal group (i.e., when the alkyl is within a larger molecule, and both ends of the alkyl are bonded to other carbons).

As used herein, a “cycloalkyl (meth)acrylate” refers to a cycloalkyl ester of a (meth)acrylic acid. A “cycloalkyl” is a carbon ring functional group (optionally with one or more substituents) of the general formula CₙH₂ₙ₋₁.

As used herein, a di(meth)acrylate refers to a compound that includes two (meth)acrylate groups. Such compounds can be formed by reacting (meth)acrylic acid with a diol, for example.

As used herein, a “substituted” compound is a compound in which at least one hydrogen has been replaced with a “substituent” group that is not hydrogen.

A non-exhaustive list of example ethylenically unsaturated monomers includes ethylene, vinyl acetate, vinyl chloride, vinylidene chloride, (meth)acrylonitrile, methyl (meth)acrylate, ethyl (meth)acrylate, butyl (meth)acrylate, 2-ethylhexyl (meth)acrylate, hydroxyethyl (meth)acrylate, hydroxypropyl (meth)acrylate, 1,3-propane diol di(meth)acrylate, 1,4-butane diol di(meth)acrylate, 1,6-hexane diol di(meth)acrylate, ethylene glycol di(meth)acrylate, benzyl (meth)acrylate, lauryl (meth)acrylate, oleyl (meth)acrylate, palmityl (meth)acrylate, and stearyl (meth)acrylate.

The set of ethylenically unsaturated monomers from which the polymer particles are formed can include an ethylenically unsaturated monomer containing acid-functionality such as (meth)acrylic acid, (meth)acryloxypropionic acid, itaconic acid, aconitic acid, maleic acid or anhydride, fumaric acid, crotonic acid, monomethyl maleate, monomethyl fumarate, and monomethyl itaconate.

The set of ethylenically unsaturated monomers from which the polymer particles are formed can also include an aromatic monomer comprising an ethylenically unsaturated group, such as styrene.

The polymer particles can have an average particle size (volume basis) of 50 nm to 500 nm, or 75 nm to 250 nm, or 95 nm to 150 nm, or be within a range that includes any combination of the foregoing values as endpoints, as measured using dynamic light scattering (DLS).

An “aqueous dispersion” refers to a dispersion of the polymer particles in an aqueous medium. An “aqueous medium” refers to a liquid medium comprising at least 50% water, based on the total weight of the liquid medium. Such aqueous liquid mediums can comprise at least 60% water, or at least 70% water, or at least 80% water, or at least 90% water, or at least 95% water, based on the total weight of the liquid medium. The other solvents that make up less than 50% of the liquid medium can include organic solvents. Non-limiting examples of suitable organic solvents include polar organic solvents (e.g., protic organic solvents such as glycols, glycol ether alcohols, alcohols, and volatile ketones, glycol diethers, esters, and diesters). Other non-limiting examples of organic solvents include aromatic and aliphatic hydrocarbons.

### Biocide Component

The biocide component of the coating composition can include (i) a first organosulfur component, (ii) a second organosulfur component different from the first organosulfur component, and (iii) an organozinc compound. The biocide component can optionally further include (iv) a nitrogen-containing heterocycle that includes an attached alkylamino group and/or an attached alkylthio group, and/or (v) a carbamate compound.

The biocide component can be included at 0.05 wt. % to 2 wt. %, such as 0.1% to 1 wt. %, or 0.5 wt. %, or can be included in an amount within a range that uses any combination of the foregoing as endpoints, based on total weight of the coating composition.

An “organosulfur component” is an organosulfur compound or mixture thereof. An “organosulfur compound” is an organic compound that contains one or more sulfur atoms. As used herein, an “organosulfur component” excludes nitrogen-containing heterocycles (e.g., triazines) with an attached alkylthio group, and excludes organozinc compounds (even if the organozinc compound includes one or more sulfur atoms) as such compounds are categorized separately herein and are not therefore considered “organosulfur components” even though they can technically be organosulfur compounds.

The first organosulfur component, the second organosulfur component, or both can comprise a sulfenamide group.

The first organosulfur component, the second organosulfur component, or both can comprise a heterocycle structure.

The first organosulfur component can comprise a monocyclic heterocycle, such as a monocyclic isothiazolinone-based compound. For example, the first organosulfur component can comprise a monocyclic isothiazolinone-based compound that includes an attached C1-C8 alkyl group and/or an attached halo group. For example, the first organosulfur component can comprise a chloromethylisothiazolinone (CMIT) (e.g., 5-chloro-2-methyl-4-isothiazolin-3-one), a methylisothiazolinone (MIT) (e.g., 2-methyl-4-isothiazolin-3-one), and/or an octylisothiazolinone (e.g., 2-octyl-4-isothiazolin-3-one), such as according to the respective formulas:

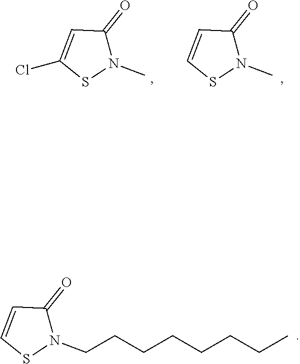

The first organosulfur component can comprise a mixture of multiple different monocyclic isothiazolinone-based compounds. For example, the first organosulfur component can comprise a mixture of both CMIT and MIT at a CMIT:MIT ratio of 1:10 to 10:1, such as 1:5 to 5:1, such as 1:1 to 5:1, such as 2:1 to 3:1, or be within a range of ratios that uses any combination of the foregoing ratios as endpoints.

The second organosulfur component can comprise a bicyclic heterocycle, such as a bicyclic isothiazolinone-based compound, such as benzisothiazolinone (BIT) (e.g., 1,2-benzothiazol-3-one), such as according to the formula:

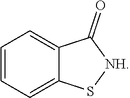

When the first organosulfur component comprises a monocyclic isothiazolinone-based compound and the second organosulfur component comprises a bicyclic isothiazolinone-based compound, the bicyclic isothiazolinone-based compound can be included in an amount, by weight, that is greater than the monocyclic isothiazolinone-based compound, such as greater by a factor of 2.5 or more, such as greater by a factor of 5 or more, such as greater by a factor of 10 or more, such as greater by a factor of 15 or more, such as greater by a factor of 20 or more, or is greater by a factor within a range that uses any combination of the foregoing values as endpoints.

The first organosulfur component and the second organosulfur component can together account for 2.5 wt. % to 55 wt. %, such as 5 wt. % to 50 wt. %, or a range that uses any combination of the foregoing values as endpoints, of the total weight of biocides included in the coating composition.

An “organozinc compound” is an organic compound that contains one or more zinc atoms. The organozinc compound can include a coordination complex of zinc, such as a tetrahedral coordination complex of zinc, such as zinc pyrithione:

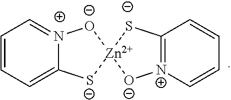

The organozinc compound can be included at 10 wt. % to 90 wt. %, such as 15 wt. % to 85 wt. %, or within a range that uses any combination of the foregoing values as endpoints, based on total weight of biocides included in the coating composition.

The nitrogen-containing heterocycle can include a triazine that includes an attached alkylamino group and/or an attached alkylthio group, such as two attached alkylamino groups and an attached alkylthio group, such as terbutryn (i.e., a 1,3,5-triazine that includes attached tert-butylamino, ethylamino, and methylthio groups), which has the formula:

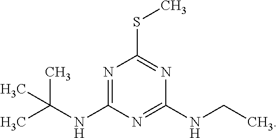 [SMILES: CCNc1nc(NC(C)(C)C)nc(SC)n1]

The nitrogen-containing heterocycle can be included at 20 wt. % to 50 wt. %, such as 25 wt. % to 45 wt. %, such as 30 wt. % to 40 wt. %, or within a range that uses any combination of the foregoing values as endpoints, based on total weight of biocides included in the coating composition.

As stated above, a nitrogen-containing heterocycle with attached alkylthio group is categorized separately from an organosulfur component herein.

The carbamate compound can include a carbamate substituted with an alkyl, aryl, alkenyl, and/or alkenyl substituent. The substituent can optionally include a halogen. For example, the carbamate compound can include iodopropynyl butylcarbamate (IPBC), which has the formula:

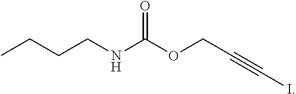

The carbamate compound can be included at 5 wt. % to 30 wt. %, such as 7.5 wt. % to 25 wt. %, such as 10 wt. % to 20 wt. %, or within a range that uses any combination of the foregoing values as endpoints, based on total weight of biocides included in the coating composition.

The coating composition can include a weight ratio of organosulfur compounds to organozinc compounds of 20:1 to 1:30, such as 15:1 to 1:25, such as 10:1 to 1:20, such as 5:1 to 1:15, such as 1:1 to 1:15, or can be within a range of ratios that uses any combination of the foregoing ratios as endpoints.

The coating composition can completely omit or essentially omit copper-based and/or tin-based biocides.

### Other Coating Composition Components

The coating composition can include other components including, for example, pigments, pH modifiers, rheological modifiers, dispersing aids, antifoam agents, other solvents, extenders, wetting agents, plasticizers, thixotropic agents, anti-settling agents, diluents, UV light stabilizers, air release agents, and/or other coating composition components as known in the art.

### Additional Terms & Definitions

While certain aspects of the present disclosure have been described in detail, with reference to specific components and/or features, the descriptions are illustrative and are not to be construed as limiting the scope of the claimed coating composition or related methods.

For any given component of a described example, any of the possible alternatives disclosed for that component may generally be used individually or in combination with one another, unless implicitly or explicitly stated otherwise.

The various features of a given example can be combined with and/or incorporated into other examples disclosed herein. Thus, disclosure of certain features relative to a specific example should not be construed as limiting application or inclusion of said features to the specific example. Rather, it will be appreciated that other examples can also include such features.

Any headings and subheadings used herein are for organizational purposes only and are not meant to be used to limit the scope of the description or the claims.

Any standard testing method discussed herein (e.g., ASTM) will be understood to refer to the most recent version of the testing method available at the time of filing of this disclosure, unless specified otherwise.

As used in this specification and the appended claims, the singular forms “a,” “an” and “the” do not exclude plural referents unless the context clearly dictates otherwise. Thus, for example, an embodiment referencing a singular biocide may also include two or more such biocides.

The example compositions and methods disclosed herein should be understood as comprising/including disclosed components/steps, and may therefore include additional components/steps not specifically described. Optionally, the example compositions disclosed herein “consist of” or “consist essentially of” the disclosed components or a subset thereof. For example, the disclosed compositions can be essentially free or completely free of components that are not specifically described, and non-disclosed components may optionally be completely omitted or essentially omitted from the disclosed examples. For example, biocides and/or binder components not specifically disclosed herein may optionally be completely omitted or essentially omitted from the disclosed coating composition.

A composition that “essentially omits” or is “essentially free of” a component may include trace amounts and/or non-functional amounts of the component. For example, an “essentially omitted” component may be included in an amount no more than 1%, no more than 0.1%, or no more than 0.01% by total weight of the composition.

A composition that “completely omits” or is “completely free of” a component does not include a detectable amount of the component (i.e., does not include an amount above any inherent background signal associated with the testing instrument) when analyzed using standard coating composition analysis techniques such as, for example, chromatographic techniques (e.g., thin-layer chromatography (TLC), gas chromatography (GC), liquid chromatography (LC)), or spectroscopy techniques (e.g., Fourier transform infrared (FTIR) spectroscopy).

### Example Aspects

The following numbered aspects represent a non-exhaustive list of example aspects of the disclosed method for treating an asphalt shingle:
Aspect 1. A method for treating an asphalt shingle, the method comprising:
   applying a coating composition to a surface of an asphalt shingle, or to granules formulated for use in a granule layer of an asphalt shingle, the coating composition comprising
   (a) a film-forming component; and
   (b) a biocide component, the biocide component comprising
      (i) a first organosulfur component,
      (ii) a second organosulfur component different from the first organosulfur component, and
      (iii) an organozinc compound,
   optionally further comprising
      (iv) a nitrogen-containing heterocycle that includes an attached alkylamino group and/or an attached alkylthio group, and/or
      (v) a carbamate compound.
Aspect 2. The method of aspect 1, wherein the first organosulfur component, the second organosulfur component, or both comprise a sulfenamide group, such as comprising a heterocycle that contains both sulfur and nitrogen atoms, such as an isothiazolinone-based compound.
Aspect 3. The method of aspect 2, wherein:
   the first organosulfur component comprises a monocyclic heterocycle, such as a monocyclic isothiazolinone-based compound, such as a monocyclic isothiazolinone-based compound that includes an attached C1-C8 alkyl group and/or an attached halo group, and/or
   the second organosulfur component comprises a bicyclic heterocycle, such as a bicyclic isothiazolinone-based compound.
Aspect 4. The method of aspect 3, wherein the first organosulfur component comprises a monocyclic isothiazolinone-based compound and the second organosulfur component comprises a bicyclic isothiazolinone-based compound, wherein the bicyclic isothiazolinone-based compound is included in an amount, by weight, that is greater than an amount, by weight, of the monocyclic isothiazolinone-based compound,
   such as greater by a factor of 2.5 or more, such as greater by a factor of 5 or more, such as greater by a factor of 10 or more, such as greater by a factor of 15 or more, such as greater by a factor of 20 or more,
   such as greater by a factor of 2.5 to 20, or 5 to 15, or 10, or by a factor within a range that uses any combination of the foregoing values as endpoints.
Aspect 5. The method of aspect 3 or aspect 4, wherein:
   the first organosulfur component comprises chloromethylisothiazolinone (CMIT), methylisothiazolinone (MIT), and/or octylisothiazolinone, such as wherein the first organosulfur component comprises a mixture of both CMIT and MIT; and/or
   the second organosulfur component comprises benzisothiazolinone (BIT).
Aspect 6. The method of aspect 5, wherein the first organosulfur component comprises a mixture of both CMIT and MIT at a CMIT:MIT ratio of 1:10 to 10:1, such as 1:5 to 5:1, such as 1:1 to 5:1, such as 2:1 to 3:1, or within a range of ratios that uses any combination of the foregoing ratios as endpoints,
   such as wherein the first organosulfur component comprises a monocyclic isothiazolinone-based compound and the second organosulfur component comprises a bicyclic isothiazolinone-based compound, wherein the bicyclic isothiazolinone-based compound is included in an amount, by weight, that is greater than an amount, by weight, of the monocyclic isothiazolinone-based compound by a factor of:
      2.5 or more, and the first organosulfur component comprises a mixture of both CMIT and MIT at a CMIT:MIT ratio of 1:10 to 10:1, such as 1:5 to 5:1, such as 1:1 to 5:1, such as 2:1 to 3:1, or within a range of ratios that uses any combination of the foregoing ratios as endpoints,
      5 or more, and the first organosulfur component comprises a mixture of both CMIT and MIT at a CMIT:MIT ratio of 1:10 to 10:1, such as 1:5 to 5:1, such as 1:1 to 5:1, such as 2:1 to 3:1, or within a range of ratios that uses any combination of the foregoing ratios as endpoints,
      10 or more, and the first organosulfur component comprises a mixture of both CMIT and MIT at a CMIT:MIT ratio of 1:10 to 10:1, such as 1:5 to 5:1, such as 1:1 to 5:1, such as 2:1 to 3:1, or within a range of ratios that uses any combination of the foregoing ratios as endpoints,
      15 or more, and the first organosulfur component comprises a mixture of both CMIT and MIT at a CMIT:MIT ratio of 1:10 to 10:1, such as 1:5 to 5:1, such as 1:1 to 5:1, such as 2:1 to 3:1, or within a range of ratios that uses any combination of the foregoing ratios as endpoints,
      20 or more, and the first organosulfur component comprises a mixture of both CMIT and MIT at a CMIT:MIT ratio of 1:10 to 10:1, such as 1:5 to 5:1, such as 1:1 to 5:1, such as 2:1 to 3:1, or within a range of ratios that uses any combination of the foregoing ratios as endpoints.
Aspect 7. The method of any preceding aspect, wherein the organozinc compound comprises a coordination complex of zinc, such as a tetrahedral coordination complex of zinc, such as zinc pyrithione.
Aspect 8. The method of any preceding aspect, wherein the nitrogen-containing heterocycle comprises a triazine that includes an attached alkylamino group and/or an attached alkylthio group, such as two attached alkylamino groups and an attached alkylthio group, such as terbutryn.
Aspect 9. The method of any preceding aspect, wherein the carbamate compound comprises a carbamate compound substituted with an alkyl, aryl, alkenyl, and/or alkenyl substituent, the substituent optionally including a halogen, such as iodopropynyl butylcarbamate (IPBC).
Aspect 10. The method of any preceding aspect, wherein the coating composition includes a weight ratio of organosulfur compounds to organozinc compounds of 20:1 to 1:30, such as 15:1 to 1:25, such as 10:1 to 1:20, such as 5:1 to 1:15, such as 1:1 to 1:15, or within a range of ratios that uses any combination of the foregoing ratios as endpoints,
   such as wherein the first organosulfur component comprises a monocyclic isothiazolinone-based compound and the second organosulfur component comprises a bicyclic isothiazolinone-based compound, wherein the bicyclic isothiazolinone-based compound is included in an amount, by weight, that is greater than an amount, by weight, of the monocyclic isothiazolinone-based compound by a factor of:
      2.5 or more, and the coating composition includes a weight ratio of organosulfur compounds to organozinc compounds of 20:1 to 1:30, 15:1 to 1:25, 10:1 to 1:20, 5:1 to 1:15, 1:1 to 1:15, or is within a range of ratios that uses any combination of the foregoing ratios as endpoints,
      5 or more, and the coating composition includes a weight ratio of organosulfur compounds to organozinc compounds of 20:1 to 1:30, 15:1 to 1:25, 10:1 to 1:20, 5:1 to 1:15, 1:1 to 1:15, or is within a range of ratios that uses any combination of the foregoing ratios as endpoints,
      10 or more, and the coating composition includes a weight ratio of organosulfur compounds to organozinc compounds of 20:1 to 1:30, 15:1 to 1:25, 10:1 to 1:20, 5:1 to 1:15, 1:1 to 1:15, or is within a range of ratios that uses any combination of the foregoing ratios as endpoints,
      15 or more, and the coating composition includes a weight ratio of organosulfur compounds to organozinc compounds of 20:1 to 1:30, 15:1 to 1:25, 10:1 to 1:20, 5:1 to 1:15, 1:1 to 1:15, or is within a range of ratios that uses any combination of the foregoing ratios as endpoints,
      20 or more, and the coating composition includes a weight ratio of organosulfur compounds to organozinc compounds of 20:1 to 1:30, 15:1 to 1:25, 10:1 to 1:20, 5:1 to 1:15, 1:1 to 1:15, or is within a range of ratios that uses any combination of the foregoing ratios as endpoints, or
   such as wherein the first organosulfur component comprises a mixture of both CMIT and MIT at a CMIT:MIT ratio of:
      1:10 to 10:1, and the coating composition includes a weight ratio of organosulfur compounds to organozinc compounds of 20:1 to 1:30, 15:1 to 1:25, 10:1 to 1:20, 5:1 to 1:15, 1:1 to 1:15, or is within a range of ratios that uses any combination of the foregoing ratios as endpoints,
      1:5 to 5:1, and the coating composition includes a weight ratio of organosulfur compounds to organozinc compounds of 20:1 to 1:30, 15:1 to 1:25, 10:1 to 1:20, 5:1 to 1:15, 1:1 to 1:15, or is within a range of ratios that uses any combination of the foregoing ratios as endpoints,
      1:1 to 5:1, and the coating composition includes a weight ratio of organosulfur compounds to organozinc compounds of 20:1 to 1:30, 15:1 to 1:25, 10:1 to 1:20, 5:1 to 1:15, 1:1 to 1:15, or is within a range of ratios that uses any combination of the foregoing ratios as endpoints,
      2:1 to 3:1, and the coating composition includes a weight ratio of organosulfur compounds to organozinc compounds of 20:1 to 1:30, 15:1 to 1:25, 10:1 to 1:20, 5:1 to 1:15, 1:1 to 1:15, or is within a range of ratios that uses any combination of the foregoing ratios as endpoints.
Aspect 11. The method of any preceding aspect, wherein the biocide component of the coating composition is included at 0.05 wt. % to 2 wt. %, such as 0.1% to 1 wt. %, or 0.5 wt. %, or is included in an amount within a range that uses any combination of the foregoing as endpoints, based on total weight of the coating composition,
   such as wherein the first organosulfur component comprises a monocyclic isothiazolinone-based compound and the second organosulfur component comprises a bicyclic isothiazolinone-based compound, wherein the bicyclic isothiazolinone-based compound is included in an amount, by weight, that is greater than an amount, by weight, of the monocyclic isothiazolinone-based compound by a factor of:
      2.5 or more, and the biocide component of the coating composition is included at 0.05 wt. % to 2 wt. %, such as 0.1% to 1 wt. %, or 0.5 wt. %, or is included in an amount within a range that uses any combination of the foregoing as endpoints, based on total weight of the coating composition,
      5 or more, and the biocide component of the coating composition is included at 0.05 wt. % to 2 wt. %, such as 0.1% to 1 wt. %, or 0.5 wt. %, or is included in an amount within a range that uses any combination of the foregoing as endpoints, based on total weight of the coating composition,
      10 or more, and the biocide component of the coating composition is included at 0.05 wt. % to 2 wt. %, such as 0.1% to 1 wt. %, or 0.5 wt. %, or is included in an amount within a range that uses any combination of the foregoing as endpoints, based on total weight of the coating composition,
      15 or more, and the biocide component of the coating composition is included at 0.05 wt. % to 2 wt. %, such as 0.1% to 1 wt. %, or 0.5 wt. %, or is included in an amount within a range that uses any combination of the foregoing as endpoints, based on total weight of the coating composition,
      20 or more, and the biocide component of the coating composition is included at 0.05 wt. % to 2 wt. %, such as 0.1% to 1 wt. %, or 0.5 wt. %, or is included in an amount within a range that uses any combination of the foregoing as endpoints, based on total weight of the coating composition, or
   such as wherein the first organosulfur component comprises a mixture of both CMIT and MIT at a CMIT:MIT ratio of:
      1:10 to 10:1, and the biocide component of the coating composition is included at 0.05 wt. % to 2 wt. %, such as 0.1% to 1 wt. %, or 0.5 wt. %, or is included in an amount within a range that uses any combination of the foregoing as endpoints, based on total weight of the coating composition,
      1:5 to 5:1, and the biocide component of the coating composition is included at 0.05 wt. % to 2 wt. %, such as 0.1% to 1 wt. %, or 0.5 wt. %, or is included in an amount within a range that uses any combination of the foregoing as endpoints, based on total weight of the coating composition,
      1:1 to 5:1, and the biocide component of the coating composition is included at 0.05 wt. % to 2 wt. %, such as 0.1% to 1 wt. %, or 0.5 wt. %, or is included in an amount within a range that uses any combination of the foregoing as endpoints, based on total weight of the coating composition,
      2:1 to 3:1, and the biocide component of the coating composition is included at 0.05 wt. % to 2 wt. %, such as 0.1% to 1 wt. %, or 0.5 wt. %, or is included in an amount within a range that uses any combination of the foregoing as endpoints, based on total weight of the coating composition, or
   such as wherein the coating composition includes a weight ratio of organosulfur compounds to organozinc compounds of
      20:1 to 1:30, and the biocide component of the coating composition is included at 0.05 wt. % to 2 wt. %, such as 0.1% to 1 wt. %, or 0.5 wt. %, or is included in an amount within a range that uses any combination of the foregoing as endpoints, based on total weight of the coating composition,
      15:1 to 1:25, and the biocide component of the coating composition is included at 0.05 wt. % to 2 wt. %, such as 0.1% to 1 wt. %, or 0.5 wt. %, or is included in an amount within a range that uses any combination of the foregoing as endpoints, based on total weight of the coating composition,
      10:1 to 1:20, and the biocide component of the coating composition is included at 0.05 wt. % to 2 wt. %, such as 0.1% to 1 wt. %, or 0.5 wt. %, or is included in an amount within a range that uses any combination of the foregoing as endpoints, based on total weight of the coating composition,
      5:1 to 1:15, and the biocide component of the coating composition is included at 0.05 wt. % to 2 wt. %, such as 0.1% to 1 wt. %, or 0.5 wt. %, or is included in an amount within a range that uses any combination of the foregoing as endpoints, based on total weight of the coating composition,
      1:1 to 1:15, and the biocide component of the coating composition is included at 0.05 wt. % to 2 wt. %, such as 0.1% to 1 wt. %, or 0.5 wt. %, or is included in an amount within a range that uses any combination of the foregoing as endpoints, based on total weight of the coating composition.
Aspect 12. The method of any preceding aspect, wherein the film-forming component comprises an aqueous dispersion of polymer particles.
Aspect 13. The method of aspect 12, wherein the polymer particles are formed from a set of ethylenically unsaturated monomers, such as a set of ethylenically unsaturated monomers comprising
   a (meth)acrylate monomer, and
   optionally, an aromatic monomer including an ethylenically unsaturated group, such as styrene.
Aspect 14. The method of any preceding aspect, wherein treating the asphalt shingle comprises prolonging the effective life of the asphalt shingle relative to the same asphalt shingle not treated by the method.
Aspect 15. The method of any preceding aspect, wherein treating the asphalt shingle comprises reducing algal growth on or within the asphalt shingle relative to the same asphalt shingle not treated by the method.
Aspect 16. The method of any preceding aspect, wherein the coating composition essentially omits or completely omits copper-based or tin-based biocides.
Aspect 17. The method of any one of aspects 1-16, wherein the method comprises applying the coating composition to the surface of an asphalt shingle while the asphalt shingle is in place upon a roof.
Aspect 18. The method of any one of aspects 1-16, wherein the method comprises applying the coating composition to the surface of an asphalt shingle before placement of the asphalt shingle on a roof.
Aspect 19. The method of any one of aspects 1-16, wherein the method comprises applying the coating composition to granules prior to placement of the granules on an asphalt mixture layer of an asphalt shingle.

### EXAMPLES

### Materials & Methods

Two different coating compositions were applied to asphalt shingle samples and algal growth on the asphalt shingles was monitored. Testing utilized the materials listed in Table 1.

TABLE 1
Materials

| | |
|---|---|
| Asphalt | Shingles sold under the trade name STREAKGUARD (Owens Corning, |
| Shingles | Toledo, OH). |
| | “AP shingles”: reference shingles, algae prevention (AP) |
| | provided by integrated copper-based biocide. |
| | “Non-AP shingles”: same as AP shingles but without copper-based biocide. |
| Coating | Both test compositions = styrene/acrylic copolymer latex (binder |
| Compositions^{1, 2} | solids included at 20 wt. % based on total weight of composition) |
| | Coating Composition 1: organosulfur / organozinc / |
| | carbamate biocide. |
| | Coating Composition 2: organosulfur / organozinc / triazine |
| | biocide. |
| Algae Strains | Nostoc sp. CCAP 1453/29 |
| | Stichococcus bacillaris CCAP 379/1A |
| | Klebsormidium flaccidum CCAP 335/2A |
| | Trentepohlia odorata CCAP 483/4 |
| | Trentepohlia aurea CCAP 483/1 |
| | Nostoc punctiforme CCAP 1453/3 |

¹Similar to the acrylic/vinyl coating disclosed in U.S. Pat. No. 8,058,342 (exemplified by copper sulfate biocide) but with different biocide formulations as indicated herein.
²Differences in binder amount and/or in ratio of styrene to acrylic not expected to substantially affect biocide effects.

Further details regarding the biocides included in Coating Composition 1 and Coating Composition 2 are shown in Tables 2A and 2B.

TABLE 2A
Biocide Details for Coating Composition 1
Coating Composition 1 (includes 0.4 wt. %
biocides based on total weight of composition)

| | | Biocide Amount |
|---|---|---|
| | | (based on total |
| Biocide Type: | | biocide weight) |
| First organosulfur | CMIT/MIT mixture | 0.2 wt. % |
| component: | at 3:1 ratio | |
| Second organosulfur | BIT | 5.5 wt. % |
| component: | | |
| Organozinc compound: | Zinc pyrithione | 83.0 wt. % |
| Carbamate compound: | IPBC | 11.3 wt. % |

TABLE 2B
Biocide Details for Coating Composition 2
Coating Composition 2 (includes 0.1 wt. %
biocides based on total weight of composition)

| | | Biocide Amount |
|---|---|---|
| | | (based on total |
| Biocide Type: | | biocide weight) |
| First organosulfur | CMIT/MIT mixture | 0.9 wt. % |
| component: | at 3:1 ratio | |
| | Octylisothiazolinone | 18.9 wt. % |
| Second organosulfur | BIT | 27.7 wt. % |
| component: | | |
| Organozinc compound: | Zinc pyrithione | 18.9 wt. % |
| N-containing heterocycle: | Terbutryn | 11.3 wt. % |

Test samples were divided into four separate treatment groups, as indicated below. Each treatment group included 6 test shingles each sized 5 cm×5 cm.
1. AR shingles (positive control)
2. Non-AR shingles coated with Coating Composition 1
3. Non-AR shingles coated with Coating Composition 2
4. Non-AR shingles uncoated (negative control)

For the test shingles treated with a coating composition, two layers were applied. The test shingles were allowed to dry for 10 days before proceeding with the testing.

The algae strains listed in Table 1 were used to contaminate the shingles in each treatment group. Individual algae strains were regenerated from stock cultures by adding a 10% inoculum of old culture in fresh Bold's Basal broth and incubated under greenhouse light (1000 lux/16 h/day) at 22±2° C., 65+5% RH for three weeks.

Each test shingle was placed into an empty, sterile petri dish and exposed to UV light for 2 minutes for surface disinfection. Algae cultures were then combined in equal volumes to form a suspension, which was then added to the petri dishes so that test specimens were covered (20 ml volume was used). The petri dishes were incubated with closed lids under greenhouse light (1000 lux/16 h/day) at 22±2° C., 65+5% RH, until evaluation of algae growth after 7 days.

### Results

After 7 days, the test shingles were removed from the algae suspension and visually evaluated for surface algae growth. Results are shown in Table 3A using the rating shown in Tables 3B and 3C. Microscopic examination was used to aid the evaluation process. After the first evaluation, the test shingles were washed with tap water (time=1 min; water pressure=2-3 bar). After washing, the test shingles were re-evaluated with the same rating as in the initial (pre-wash) evaluation.

TABLE 3A
Algae Growth on Test Shingles after 7 Days of Incubation

| | Before | After |
|---|---|---|
| Samples | washing | washing |
| AR shingles (positive control) | 5 (++) | 1 |
| Non-AR shingles coated with | 0 | 0 |
| Coating Composition 1 | | |
| Non-AR shingles coated with | 1 | 0 |
| Coating Composition 2 | | |
| Non-AR shingles uncoated | 5 (+++) | 1 |
| (negative control) | | |

TABLE 3B
Algae Growth Rating Explanations

| | Estimated surface area contaminated with | Level of |
|---|---|---|
| Rating | algae growth | inhibition |
| 0 | No growth | Excellent inhibition |
| 1 | Traces of growth | Good inhibition |
| 2 | 1-10% of the surface covered with algae | Fair inhibition |
| 3 | 11-30% of the surface covered with algae | Weak inhibition |
| 4 | 31-70% of the surface covered with algae | Poor inhibition |
| 5 | 71-100% of the surface covered with algae | No inhibition |

TABLE 3C
Algae Growth Intensity Explanations

| | |
|---|---|
| + | weak growth |
| ++ | moderate growth |
| +++ | abundant, strong growth |

As shown, the test shingles treated with Coating Composition 1 or Coating Composition 2 exhibited little or no algae growth even before washing, performing better than even the copper-based biocide of the positive control in inhibiting algae growth.

1. A method for treating an asphalt shingle, the method comprising:
applying a coating composition to a surface of an asphalt shingle, or to granules formulated for use in a granule layer of an asphalt shingle, the coating composition comprising
(a) a film-forming component; and
(b) a biocide component, the biocide component comprising
(i) a first organosulfur component,
(ii) a second organosulfur component different from the first organosulfur component, and
(iii) an organozinc compound.

2. The method of claim 1, wherein the first organosulfur component, the second organosulfur component, or both comprise a sulfenamide group.

3. The method of claim 2, wherein:
the first organosulfur component comprises a monocyclic heterocycle, and/or
the second organosulfur component comprises a bicyclic heterocycle.

4. The method of claim 3, wherein the first organosulfur component comprises a monocyclic isothiazolinone-based compound and the second organosulfur component comprises a bicyclic isothiazolinone-based compound, wherein the bicyclic isothiazolinone-based compound is included in an amount, by weight, that is greater than an amount, by weight, of the monocyclic isothiazolinone-based compound.

5. The method of claim 3, wherein:
the first organosulfur component comprises chloromethylisothiazolinone (CMIT), methylisothiazolinone (MIT), and/or octylisothiazolinone; and/or
the second organosulfur component comprises benzisothiazolinone (BIT).

6. The method of claim 5, wherein the first organosulfur component comprises a mixture of both CMIT and MIT at a CMIT:MIT ratio of 1:10 to 10:1.

7. The method of claim 1, wherein the organozinc compound comprises a coordination complex of zinc.

8. The method of claim 1, wherein the biocide component further comprises a nitrogen-containing heterocycle that includes an attached alkylamino group and/or an attached alkylthio group.

9. The method of claim 1, wherein the biocide component further comprises a carbamate compound.

10. The method of claim 1, wherein the coating composition includes a weight ratio of organosulfur compounds to organozinc compounds of 20:1 to 1:30.

11. The method of claim 1, wherein the biocide component of the coating composition is included at 0.05 wt. % to 2 wt. %.

12. The method of claim 1, wherein the film-forming component comprises polymer particles.

13. The method of claim 12, wherein the polymer particles are formed from a set of ethylenically unsaturated monomers comprising
a (meth)acrylate monomer, and
optionally, an aromatic monomer including an ethylenically unsaturated group.

14. The method of claim 1, wherein treating the asphalt shingle comprises prolonging the effective life of the asphalt shingle relative to the same asphalt shingle not treated by the method and/or comprises reducing algal growth on or within the asphalt shingle relative to the same asphalt shingle not treated by the method.

15. The method of claim 1, wherein the coating composition essentially omits or completely omits copper-based or tin-based biocides.

16. The method of claim 1, wherein the method comprises applying the coating composition to the surface of an asphalt shingle while the asphalt shingle is in place upon a roof.

17. The method of claim 1, wherein the method comprises applying the coating composition to the surface of an asphalt shingle before placement of the asphalt shingle on a roof.

18. The method of claim 1, wherein the method comprises applying the coating composition to granules prior to placement of the granules on an asphalt mixture layer of an asphalt shingle.

19. The method of claim 2, wherein the first organosulfur component, the second organosulfur component, or both comprise a heterocycle that contains both sulfur and nitrogen atoms.

20. The method of claim 19, wherein the first organosulfur component, the second organosulfur component, or both comprise an isothiazolinone-based compound.
